(19) United States
(12) Patent Application Publication
(10) Pub. No.: US 2019/0050842 A1
(43) Pub. Date: Feb. 14, 2019

(54) CLOUD-BASED ON-PREMISE PAYMENT METHOD

(71) Applicant: Aero Payments, LLC, Chicago, IL (US)

(72) Inventor: Daniel Muller, Chicago, IL (US)

(21) Appl. No.: 16/102,205

(22) Filed: Aug. 13, 2018

Related U.S. Application Data
(60) Provisional application No. 62/544,357, filed on Aug. 11, 2017.

(51) Int. Cl. G06Q 20/32; G06Q 20/42; H04W 4/80

(52) U.S. Cl. CPC G06Q 20/327; H04W 4/80; G06Q 20/42; G06Q 20/322

(57) ABSTRACT

A payment system and method between a consumer and a merchant is described, in which the method requires proximity between a device in possession of a consumer and a device in possession of a merchant. The system and method further includes a payment system, typically cloud-based, that allows for financial settlement of a transaction without the literal exchange of money, cards (e.g., credit or debit), or near field technology.

This application claims priority to U.S. Provisional Patent Application No. 62/544,357, filed Aug. 11, 2017 and now pending, and which is incorporated herein by reference.

### FIELD OF THE INVENTION

The present invention relates generally to a payment method and more specifically to a largely cloud-based payment system that is directed to the financial settlement of a transaction with real-time interaction between a consumer and merchant that allows a consumer to transfer funds to a merchant in the course of a transaction without the need of face-to-face interaction of a consumer and merchant, exchange of money or payment via credit/debit card.

### BACKGROUND OF THE INVENTION

Currently, there are two primary methods of paying for goods or services at a brick and mortar retailer. These methods include paper cash and credit/debit cards. These in-store methods of payment are complicated and inefficient.

Although paper cash is a direct form of payment, it is an unreliable method of measurement for proper taxation and regulation purposes, it is more susceptible to employee theft and liability issues (e.g., cash can be withdrawn or stolen on premises or in route to a bank) and it is a general inconvenience to the end consumer by having to withdraw funds from a bank or ATM (in many instances incurring a transaction fee).

Credit/debit cards are more efficient to the end consumer than paper cash, but more costly to the merchant. Merchants require expensive hardware and software (point-of-sale (POS) systems) to support credit/debit card transactions. Plastic cards can be stolen and/or data can be stripped from the card. Additionally, merchants incur a large percentage processing fee on every transaction made with a credit card by the credit card company servicing the credit card and merchants are still largely at risk of fraud arising with personal information associated with credit/debit cards when processing transactions.

### SUMMARY OF THE INVENTION

The present invention is directed to an end-to-end consumer to merchant cloud-based payment method that simplifies payment for both consumers (also referred to herein as users) and merchants relative to a transaction, such as but not limited to the purchase of a good. The payment method allows consumers to transfer funds directly, such as funds on deposit at a banking institution, in return for goods or services. The fund source, such as at the banking institution, remains private to the individual parties involved in a transaction and allows for a one-time authorization.

The technology platform of the present invention ensures a more secure in-store transaction beyond current methods of payment, avoiding traditional theft and fraud risks associated with processing a transaction. Additionally, the payment system will provide a much lower cost of payment processing to merchants as well as the opportunity for providing enhanced services, including, but not limited to, marketing, analytics and loyalty capabilities.

The payment method abstracts user specific payment information away from the point-of-transaction and reconciles the transaction remotely (e.g., “in the cloud”) in or in near real time. The payment method can leverages bluetooth to confirm a consumer/user is within a set proximity range of the merchant for payment without revealing any user specific information about the user. The payment method allows for an efficient way to process payments that can reduce the cost of a transaction for a merchant.

In an embodiment, the payment method of the present invention generally includes an end-user software application (i.e., mobile smartphone application or “app”), a merchant software application, and a cloud-based software system. The cloud-based system interacts securely with authorized banking institutions (or the equivalent of banking institutions) for transfer of funds, where authorization is separately initiated by a user and a merchant.

The end-user/consumer software application is a consumer facing tool to initiate payments at enabled stores and engage with user-associated and merchant-associated financial institutions. An end-user/consumer is able to initiate payment and respond to notifications and messaging regarding initiated payments. No personal identifiable information is resident on the software application, e.g., banking and related information (such as credit or debit card information if appropriate) does not need to be resident in the mobile device and does not need to be entered for the transaction to initiate and complete.

The merchant software application is the merchant facing tool for accepting payments at enabled stores and for participating in a transaction. The merchant is able to identify and charge customers for a purchase. No business identifiable information is or need be resident on the software application. For privacy reasons, the actual banking institution personal information, e.g., account numbers, may be kept out of transaction and application records.

A merchant can be a subscriber to the system of the present invention and such a merchant could have a plurality of brick-and-mortar stores. A merchant enables a store by subscribing to the system of the present invention and logging in at a merchant's brick and mortar location. Once a particular store is enabled, visiting users who are also system subscribers may attach to the store.

The cloud-based software system facilitates and reconciles transactions when initiated at a merchant's enabled store. The system includes the ability to maintain and record all transactions, maintain a record of all consumers and merchants on the technology platform, and communicate with relevant third-parties when necessary.

In an embodiment, the present invention is directed to a payment method that includes the following steps for a user and a merchant:

(1) Each of the user and merchant would first download a software application on a mobile phone, tablet, or the like, where the device is in their own possession; each application, once downloaded can be used numerous times for different transactions with different combinations of parties. Each device must have Bluetooth (or equivalent) and geo-location capability.

(2) Each of the user and merchant separately subscribes to the service of the present invention. Each subscription identifies the preferred banking institution and arranges for transactions with that institution (such as but not limited to assuring adequate funds are in the account).

(3) Open the software application on the user's device at an enabled store and initiate a link to the merchant's device, thereby arranging a triangular connectivity with the cloud-based system of the present invention; the connectivity with the cloud-based system is by datagram, not by a nailed-up linkage (such as provided in Bluetooth). Unlike other near field communication, the present invention only requires general geographic presence.

(4) Connecting the user software application with a merchant application (e.g., via Bluetooth Low Energy (BLE)); such connectivity is fleeting and only applicable during sufficient geo-proximity of the user's device to the merchant's device in the particular locale.

(5) Typically the user would initiate a payment request from the software application on the consumer's device where the device notifies the cloud-based system that a payment request has been initiated within a range of a merchant software application and the cloud-based system receives corresponding data and notifies the corresponding merchant software application of a payment request made by the consumer.

(6) The merchant would then receive a payment request from the consumer on the merchant software application (mobile phone; tablet or other device). The request could come directly from the consumer device or via the cloud-based system.

(7) The merchant would then accept a request from consumer to make a payment and authorizing a charge for a corresponding order value by sending authorization and an order value through the merchant application to the cloud-based system. The cloud-based system then notifies the consumer that the charge has been authorized; behind the scenes, banking authorization would happen such as to assure the presence of sufficient funds.

(8) The user would then receive authorization and a confirmation request from the merchant application on the consumer application;

(9) The user would then confirm the transaction on the consumer application and sending the confirmation to the cloud-based system so that processing of the transaction can commence; and

(10) The cloud-based system would then dereference both the consumer account and merchant account to determine the corresponding bank accounts and order value to begin the transfer of funds from the consumer to the merchant.

(11) Upon departing the locale, the triangular connectivity would break down and the connectivity between the user device and the merchant device would be broken. Such connectivity would need to be reestablished upon the next visit of the user to that same locale but the user and device becomes free to communicate with other merchants for other transactions. Each device can communicate concurrently with multiple devices, for example, multiple users can communicate with one merchant device and a user can view and select from multiple merchants in range but can only initiate a transaction with one merchant device.

### BRIEF DESCRIPTIONS OF THE DRAWINGS

FIG. 1 is a flow diagram of a known payment system;

FIG. 2 is a first flow diagram of an embodiment of the payment system of the present invention;

FIG. 3 is a second flow diagram of an embodiment of the payment system of the present invention;

FIG. 4 is an embodiment of a consumer facing application display and a merchant facing display application;

FIG. 5 is a third flow diagram of an embodiment of the BLE transaction method of the payment system of the present invention;

FIG. 6 is a fourth flow diagram of an embodiment of the QR transaction method of the payment system of the present invention

FIG. 7 is a fifth flow diagram of an embodiment of the security model of the payment system of the present invention;

FIG. 8 is a sixth flow diagram of an embodiment of the processing method of the payment system of the present invention; and

FIGS. 9A-9B (collectively FIG. 9 hereinafter) are a schematic diagram of the elements of the system of the present invention.

FIGS. 10A-10C (collectively FIG. 10 hereinafter) present a schematic diagram of the components and requisite steps of the system and process of the present invention.

### DETAILED DESCRIPTION OF EMBODIMENTS OF THE INVENTION

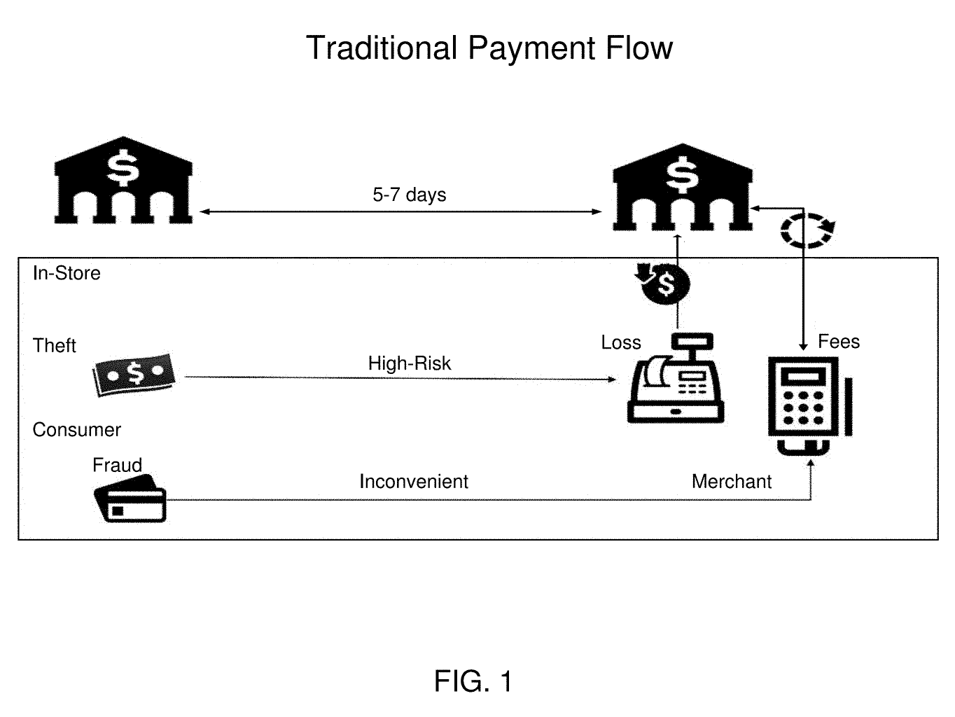

With reference now to the drawings, and in particular to FIGS. 1 through 6, embodiments of a cloud-based payment system, are described.

In its preferred form, the present invention includes three component pieces: a consumer or user app, which is a software based element residing on a consumer or user's mobile device, preferably in software; a merchant app, which corresponds to the user app but is resident preferably in software in a device in the merchant's possession and/or control; and a “cloud-based” system which may be cloud-based but is typically remote to the other pieces and includes an API for communicating with the other pieces, a notification engine, some form of transaction engine, and communications elements for communicating with both other pieces and banking (or equivalent) institutions, and being authorizable by typically a plurality of such institutions for directing moving of money. In general the present invention is subscription based, meaning that users and merchants must have validated attributes to use the service of the present invention and the present invention is only accessible for transactions when the user and the merchant are sufficiently proximal geographically, where sufficient means to have some form of direct connectivity, preferably low power, such as Bluetooth.

FIG. 1 outlines a traditional banking transaction between a consumer and a merchant. As shown, a consumer hands cash or a credit/debit card for payment to a merchant. The merchant accepts the cash or credit/debit card. When payment is made by credit/debit card, the amount owed is processed in-store and then wired to a bank. Credit/debit cards is a more efficient transaction than cash for a consumer. However, because merchants require expensive hardware and software to support credit/debit card transactions, credit/debit card transactions are more costly to the merchant. Additionally, merchants incur a large percentage fee on every transaction made with a credit card by the credit card company servicing the credit card, consumers are still largely at risk of fraud arising with personal information associated with credit/debit cards when processing transactions, and processing of credit/debit card transactions can take up to 3-5 days for the transaction to clear a banking intuition.

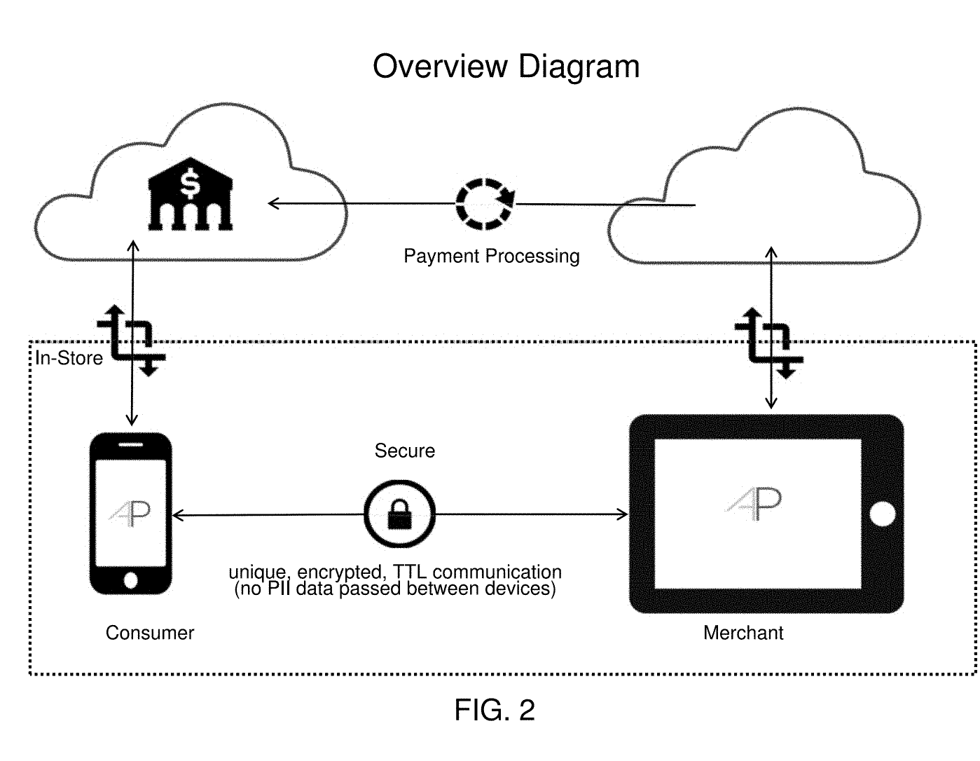

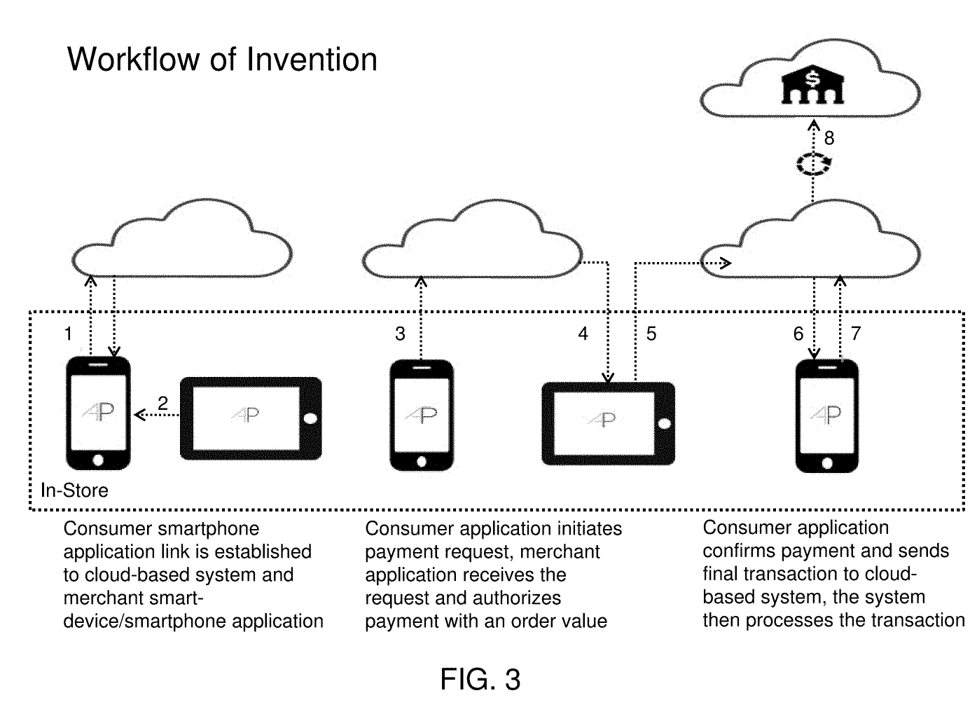

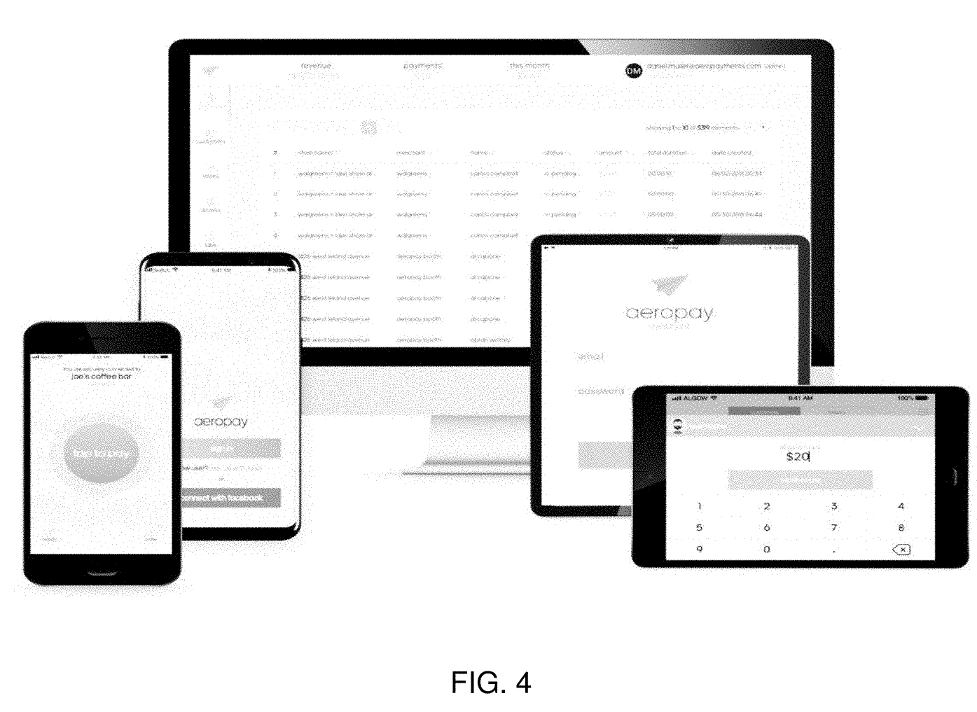

FIGS. 2 and 3 illustrate an overview of an exemplary embodiment of the payment system of the present invention. A consumer that has downloaded the payment software application of the present invention and a merchant that has set up a related software application, as shown, for example in FIG. 4, can communicate with each other and to a payment processing system (the “cloud-based” system of the present invention). The consumer can communicate with a banking institution through an intermediary and the merchant and then make a payment for an in-store purchase without the need to exchange cash with a merchant or physically use a credit/debit card.

More specifically, under select conditions a consumer application can initiate a payment request, a merchant application would then receive the request and authorize payment, the consumer would then confirm the payment and send a final transaction to the cloud-based system to process the transaction.

FIG. 4 shows an embodiment of one sample display for each of the consumer application and the merchant application.

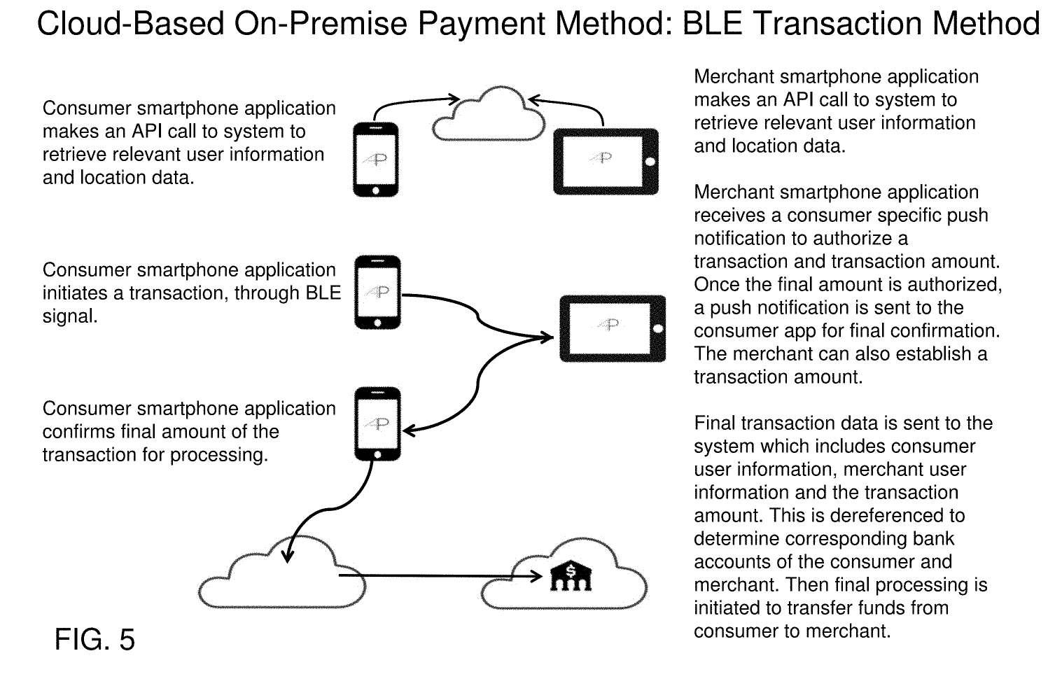

FIG. 5 shows a flow diagram of a BLE transaction method of the payment. Here, the consumer facing software application (smartphone application) makes a secure request to the server by communicating with an Application Programming Interface (API) to retrieve relevant user information and location data and the merchant software application (smartphone application) makes an API call to the system to retrieve relevant user information and provides relevant device data so as to bond with the recipient. That is, the user subscriber engages BLE connectivity with the merchant subscriber, each sends and receives data to/from the Gateway API of the system of the present invention, and three way communication for a financial transaction is established.

The consumer software application may initiate a transaction and the merchant software application would correspondingly receive a consumer specific push notification to authorize a transaction and transaction amount. Once the final amount is authorized, a push notification from the system is sent to the consumer software application (smartphone/mobile application) for final confirmation. The merchant can also establish a transaction amount. The amount of the transaction is confirmed or initiated by the consumer via the consumer software application for processing. The final transaction data is sent to the system, which includes user information, merchant information and the transaction amount. This transaction is subsequently dereferenced to determine corresponding bank accounts of the consumer and merchant. Final processing is then initiated to transfer funds from the consumer to the merchant (or vice versa, such as for a return).

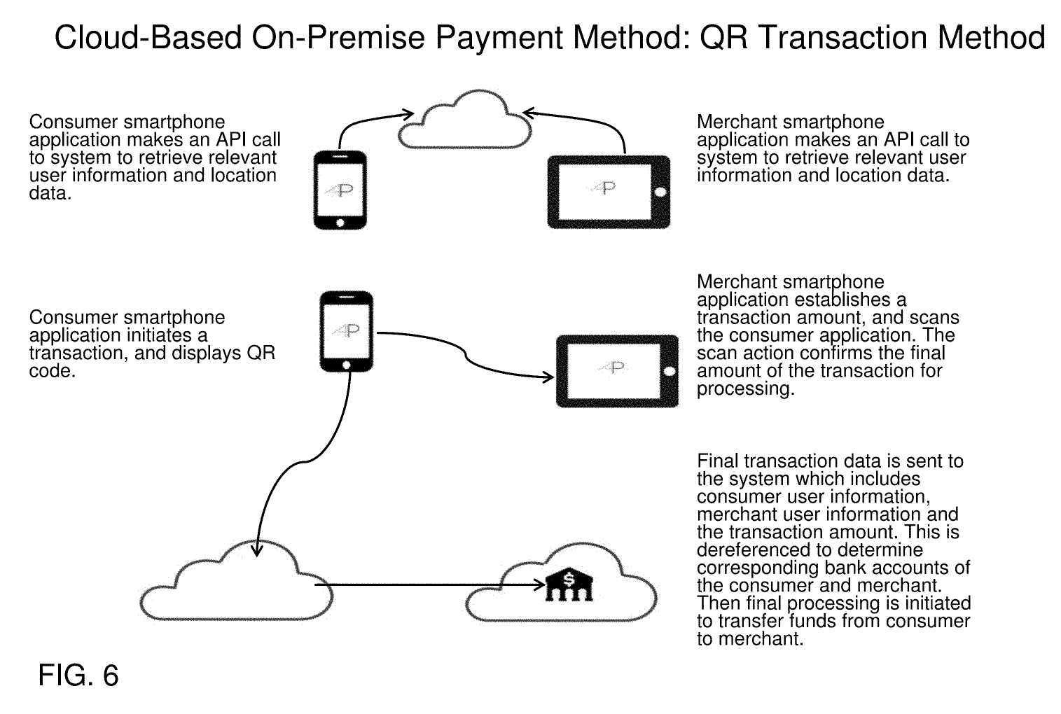

FIG. 6 shows a flow diagram of one exemplary embodiment of a QR transaction method of payment. Here, the consumer facing software application (smartphone application) makes a secure request to the server by communicating with an Application Programming Interface (API) to the system to retrieve relevant user information and location data and the merchant software application (smartphone application) makes an API call to the system to retrieve relevant user information and location data. The consumer software application initiates a transaction and may display a QR code. The merchant software application establishes a transaction amount and scans the consumer application. The scan action confirms the final amount of the transaction for processing. The final transaction data is sent to the system, which includes user information, merchant information, and the transaction amount. This is dereferenced to determine corresponding bank accounts of the consumer and merchant. Final processing is then initiated to transfer funds from the consumer to the merchant.

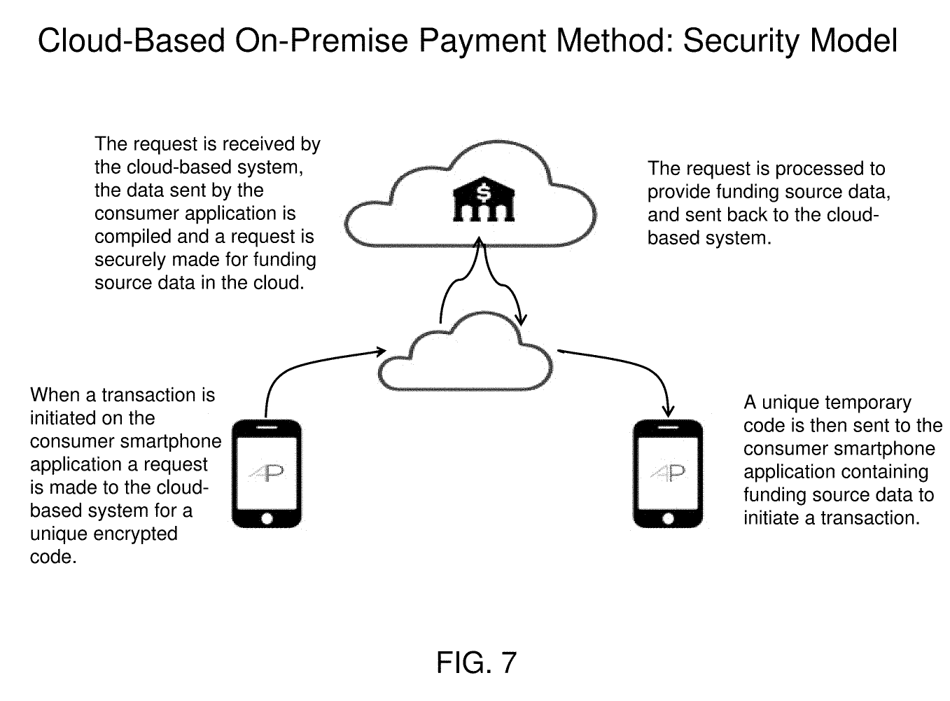

FIG. 7 shows a flow diagram of an exemplary embodiment of a security model method of payment. Here, when a transaction is initiated on the consumer software application, a request is made to the cloud-based system for a unique potentially-encrypted code or set of codes. The request is received by the cloud-based system, the data sent by the consumer application is compiled, and a request is securely made for funding source data in the cloud. The request is processed to provide funding source data and is then sent back to the cloud-based system. A unique temporary code is then sent to the consumer software application containing funding source identifier to initiate a transaction.

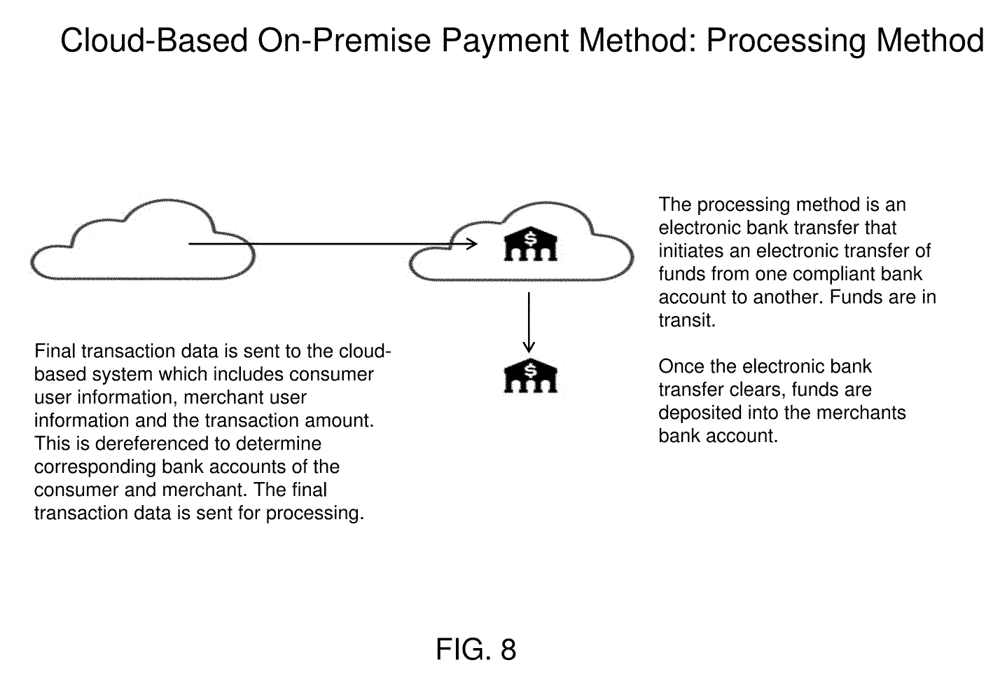

FIG. 8 shows a flow diagram of an embodiment of a processing method of payment. Here, final transaction data is sent to the cloud-based system which includes user information, merchant information and the transaction amount. This transaction is subsequently dereferenced to determine corresponding bank accounts of the consumer and merchant. The final transaction data is sent for processing. The processing method is an electronic bank transfer that initiates am electronic transfer of funds from one compliant bank account to another—funds are in transit. Once the electronic bank transfer clears, funds are deposited into the merchant bank account.

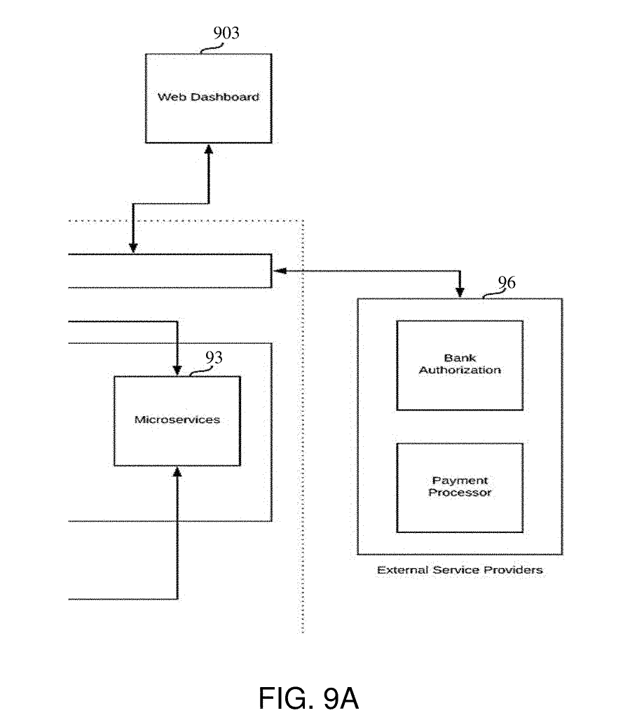

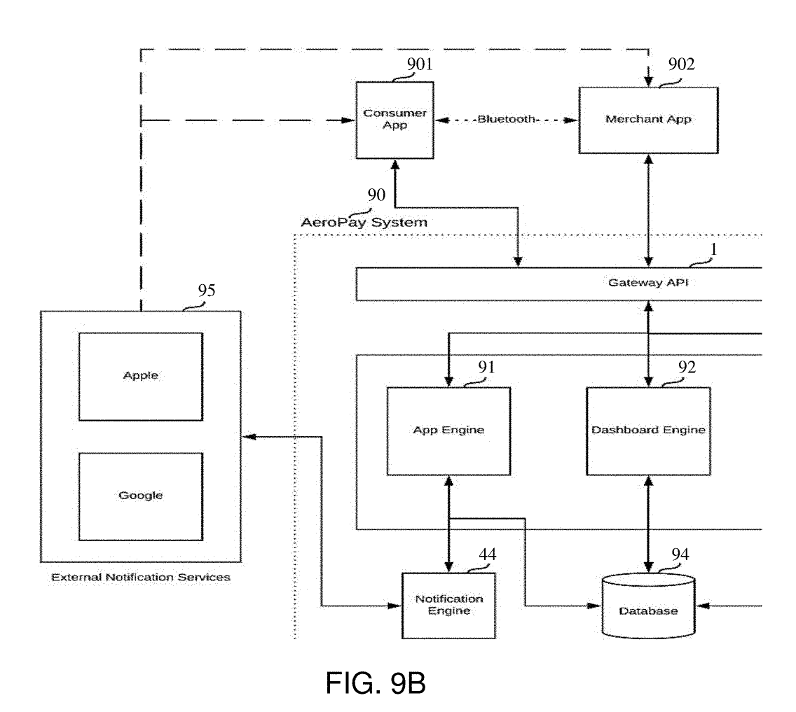

FIG. 9 depicts a schematic diagram of core elements of the present invention. The core system 90 (referred to as “AeroPay System” on the figure) includes a Gateway API 1 which serves as a communication bus with units outside the core system. The core system 90 includes an App Engine 91, a Dashboard Engine 92, Microservices 93, Notification Engine 44, and a Database 94. The system communicates to Consumer App 901, which is the application embedded in the consumer device, Merchant App 902, which is the application embedded in the merchant device, and a Web dashboard 903. External Notification Services 95 are also used to communicate with the consumer and merchant. External Service Providers 96, which also communicate to Gateway API 1, include those for Bank Authorization and Payment Processing.

The Gateway API acts as the primary communication method between the mobile and web apps and the rest of the system. The individual sub-engines, for example, the “App Engine” handle all the requests and responses that come through the Gateway API specifically, in this case, for the apps - - - consumer app and merchant app.

FIG. 9 shows a bit more detail on how the data flows through the system to help contextualize the novel portions of the invention. The intention is to demonstrate how the Gateway API handles all responses from mobile and web apps and how it distributes to these sub-engines specifically and would include the communication to the broader system which includes areas such as the “Bluetooth Protocol” and “Notification Engine”.

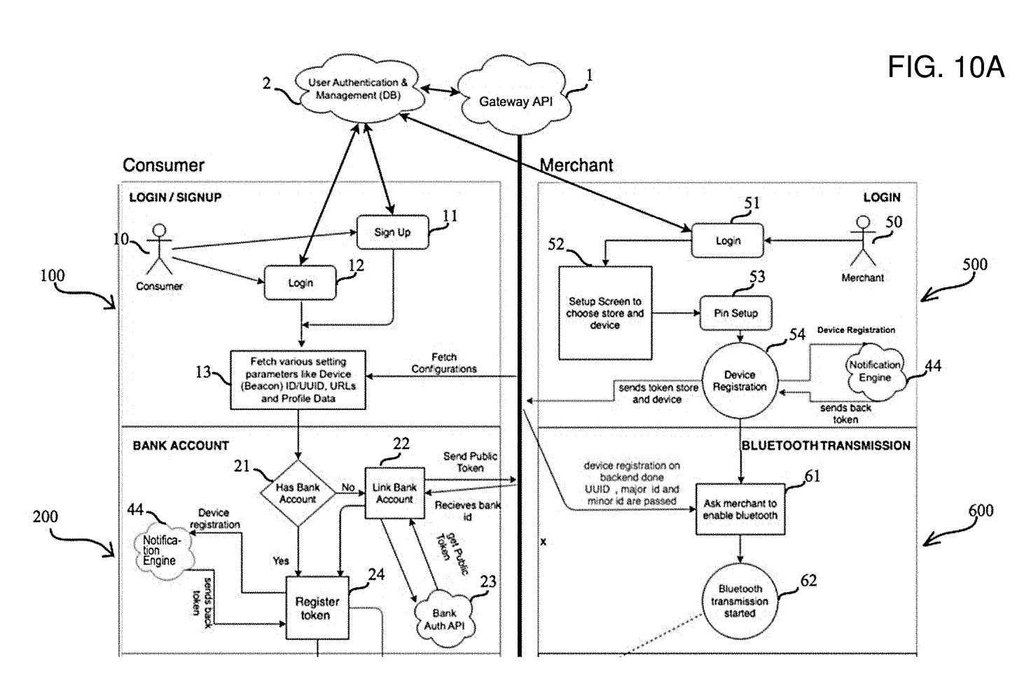

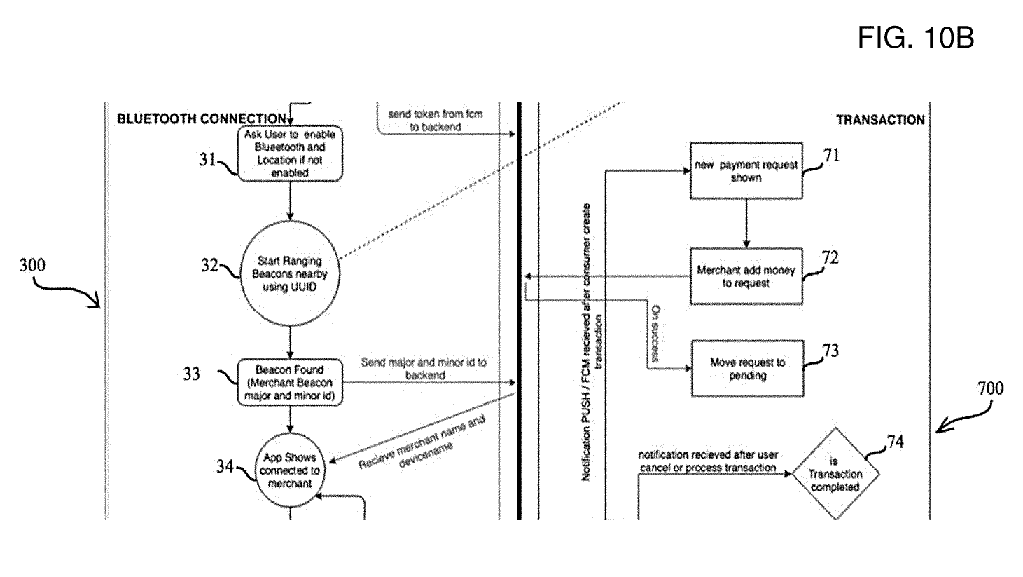

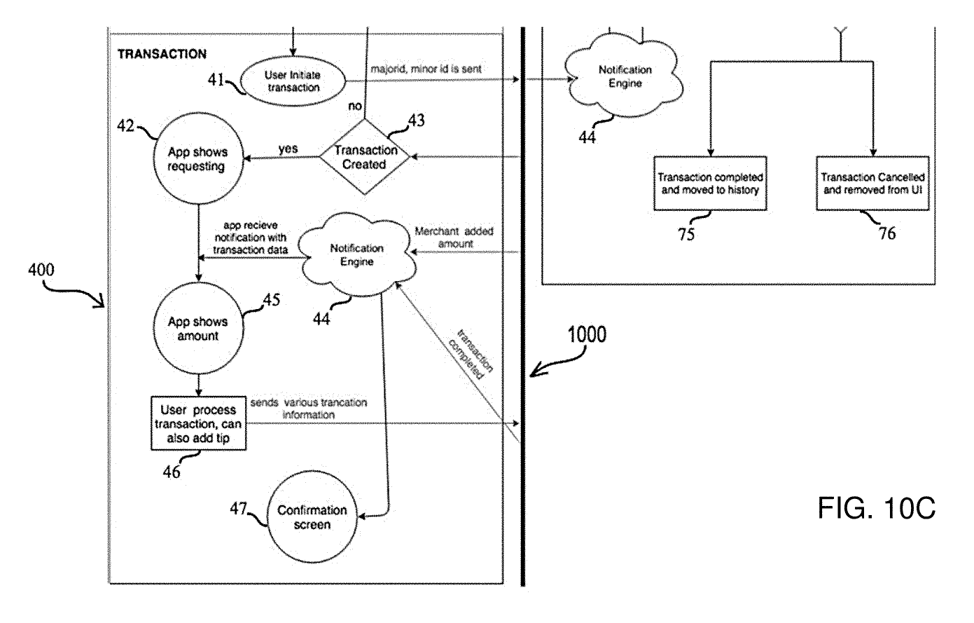

FIG. 10 depicts a schematic diagram of the elements and steps of the present invention. As shown in FIG. 10, the left side depicts user or consumer steps and the right side of the diagram depicts merchant steps in the process. Solid line 1000 in the middle indicates a Gateway API 1 to the cloud-based (preferably) system of the present invention. Not shown in FIG. 10 are any elements of the cloud-based system, except for elements shown in cloud form, such as Notification Engine 44.

FIG. 10 depicts several processes. Working from the top left, box 100 depicts the user side login/setup approach. Consumer 10 initiates sign up 11. Sign up 11 communicates with the “Backend” of the cloud-based system, in particular the cloud-based User Authentication & Management database 2. User Authentication & Management database 2 communicates with cloud-based Gateway API 1. Cloud-based Gateway API 1 is the core Application Programming Interface (API) throughout which much of the communication within the cloud-based system occurs. Returning to box 100, a user 10 begins a login (authentication) process 12. User data and device configurations are fetched 13, including but not limited to IDs, UUID, and potentially additional profile data and URLs. These data are delivered via the Gateway API 1.

Box 200 shows user registration related to a bank account and notifications. Upon login and connection with the merchant, the system of the present invention, decides if the user has a bank account 21 associated with the user. If not, a process for linking the user's bank account 22 is established and, upon success, a Bank Authorization API 23 delivers a public token to the user. The token is delivered to the system via Gateway API 1 and bank id information is returned. At the end of this process, or if it is determined that the user has a bank account, the user's device is registered with the Notification Engine 44 and a unique token is sent to the system via the Gateway API 1. Once the user registration is setup, complete and confirmed the Bluetooth process can begin.

Box 300 shows the Bluetooth (or comparable beacon) connection process. Box 31 is where the system asks the user to enable Bluetooth and location services if not enabled. Step 32 opens ranging beacons using UUID. Step 33 is where beacons are found and step 34 is when the consumer app connects to the merchant app.

Box 400 is when the consumer initiates a transaction. Step 41—the user makes the initial request which sends major id and minor id to the Notification Engine 44 which then sends the user's payment request to the merchant app. The system in return, confirms receipt of the sent data and returns a successful or failed response to the user app via the Gateway API as seen in step 43. If the transaction request fails in step 43, the user is redirected to step 34 to try again. If the request returns successfully, the app displays the request for a transaction 42. Once the amount is added on the Merchant side (step 72), the Notification Engine 44 is engaged and displays the transaction amount in step 45 and sends a confirmation screen in step 46. In step 46 the process can be amended by a consumer by either changing the transaction amount, in some cases adding a tip, or by canceling the transaction. When completed, confirmation screen 47 is provided.

On the merchant side, box 500 depicts a login process similar to that of the consumer. Merchant 50 logs in at step 51, sets up a screen to choose the store and device to be used in step 52, selects a pin in step 53, and registers the device in step 54. The Notification Engine 44 is engaged for sending tokens from the system to the device.

Box 600 depicts Bluetooth (or equivalent) transmission for the merchant. A merchant is asked to engage Bluetooth in step 61 and transmission over Bluetooth is started in step 62.

Box 700 depicts the transaction from the merchant side. The merchant app show a new payment request in step 71, the merchant adds value to the request in step 72 and, when appropriate, the transaction is moved to “pending” in step 73. When Notification Engine 44 details that the transaction is complete (step 74), the transaction is deemed complete in step 75 and canceled and removed in step 76.

Below are sample steps that explain how the system of the present invention works:
1. Merchant logs into the Merchant App
2. Merchant selects store location and device and in response a UUID, major id and minor id is provided to merchant for transmission over Bluetooth (BLE)
3. Bluetooth transmits the UUID, major id and minor id so that user device can connect to it
4. User logs into the User app.
5. User links a bank account if they have not already done so.
6. User has Bluetooth and location services turned on.
7. When the User enters the store the app automatically searches for connectivity with a Merchant app nearby with a unique UUID (same UUID as used in merchant device).
8. If there is a merchant nearby transmitting with same UUID, the user app connects to the merchant and obtains device transmitting unique Bluetooth signal (BLE) via major id and minor id.
9. Once the user app is connected to a merchant device, User can initiate the transaction by creating the payment request in the app interface.
10. On initiating a transaction, major id and minor id are passed to the Notification Engine via the Gateway API. which identifies the user and sends the Merchant a notification.
11. On receiving the notification Merchant can see user on the app, the Merchant can click on that notification, a screen will appear in which Merchant can add transaction amount. Once amount is added, a notification is sent to the user that a payment amount is added to transaction.
12. On receiving the notification from the merchant, the amount is shown in the user app for confirmation the transaction.
13. Once the user confirms the amount, the app initiates a notification to the Merchant app and the app displays a visual indicator that that the transaction has been completed by user.
14. Transaction is moved to history for both user and merchant.

### Flow Explanation Consumer App

The user/consumer side of the present invention includes modules, typically embedded in an on-board processor, encompassing the following functions:

1. User Authentication

2. Bank Authorization

3. Notification Engine

4. Bluetooth Monitoring

5. Transaction

### 1. User Authentication (Login/Signup)

A user initially performs a function to make access resident on their mobile device, such as but not limited to downloading an app from an app distributor. Once functionality is downloaded, the user needs to sign up or login to use the application. User authentication and management functionality is resident in the core system of the present invention and is used for signup and login processes.

Once the user logs in, tokens are provided by the user authentication module to create a signature for communicating with the Gateway API.

### 2. Bank Authorization

Since the app transfers money directly from a bank account, the user has to connect their bank account to the platform. Bank Authentication is used to connect a user's bank account to the platform.

Once the user initiates Bank Authentication on their device (which may be initiated before a transaction, one time at initial login, or periodically), a Bank Authorization API provides an interface for the user to choose their bank account to sync to their profile.

In order to choose a specific bank account, the user must log in and verify their bank account with their bank credentials. Bank credentials and no other confidential information are ever stored by the system.

### 3. Notification Engine

The user app leverages notifications for seamless and smooth communication of payment status between and among consumer and merchant apps.

Consumer app registers with the Notification Engine to get a unique push token, once token is provided, app communicates the token to the system so that this will be mapped to the logged in user.

### 4. Bluetooth Monitoring

This is used to connect a consumer app with the merchant app. Connectivity uses Bluetooth technology (more preferably Bluetooth Low energy, BLE). Once the user authenticates, necessary device and user configurations are fetched like profile data and bluetooth oriented UUID (beacon).

This UUID uniquely identifies a merchant device nearby as including a merchant app with a bluetooth transmission by using the same UUID. This will make sure that the connection is unique and limited to only to the merchant app, not other bluetooth devices. That is, the merchant device and the user device will “mate” through use of the same UUID.

If the user app finds a single merchant app nearby, it will connect with only that device.

If the user app finds multiple merchant apps nearby, an interface will display to the user to choose between all the devices in range. The interface list will default to the closest device in range.

Once connected to a merchant app, the user app will receive the unique major id and minor id of the merchant device. The major id and minor id will be used to uniquely identify the merchant for the transaction process. These are the unique IDs that create the distinction of each user and merchant device. Can communicate along the same Bluetooth “frequency” i.e., UUID.

The user app can only be connected to one merchant app device at a time to create a transaction.

### 5. Transaction

Once a user app is connected to a merchant device, the user can initiate a transaction process.

Once the request is acknowledged, it provides the user app with a unique transaction id and expiration time (transaction is cancelled if this time is exceeded and a transaction has not completed).

Then a notification is sent to the connected merchant that a user initiated a transaction.

The user can cancel the transaction anytime with a cancel button shown after initiating the transaction.

The Merchant adds an amount to the transaction which is communicated to the user app through a notification. A notification is sent to the consumer app that the merchant added amount in transaction.

A final amount is shown to the user for confirmation of payment.

The user can now confirm the transaction. All the information about the transaction is added to the system through the Gateway API which validates all the values and processes the transaction.

Once complete, a success message is shown to the user that transaction is done.

Flow Explanation Merchant App

These are the major functions in the Merchant app:

1. User Authentication (Login/Signup)

2. Merchant Device selection, Notification Engine

3. Bluetooth Transmission

4. Transaction

### 1. User Authentication (Login/Signup)

Once a merchant downloads the app, the merchant logs in to use the application. User authentication is used for the login process.

Once the merchant logs into the app, tokens are provided by User Authentication from the system to create a signature embedded in the merchant app for communicating with the Gateway API.

### 2. Merchant Device Selection, Notification Engine

After logging into the application, a setup page is shown where the merchant must select the store (location) and the device (name).

The app leverages notifications for seamless and smooth communication of payment status between consumer and merchant apps.

Merchant App registers with the Notification Engine to get a push token, once token is provided, the app communicates the push token, store (location) selected and device (name) selected to the system so that this will be mapped to the logged in user.

### 3. Bluetooth Transmission

This is used to transmit signal from the merchant app using Bluetooth low energy technology so that consumer app can connect.

The major id, minor id, and UUID are transmitted so that only the consumer app can connect to and identify the merchant.

### 4. Transaction

When a consumer comes in range of the merchant's Bluetooth receiver, the user app connects to it and receives the major id and minor id of the merchant. The connection can be made with multiple consumers.

When the user app initiates the transaction, the system checks the mapping of major id and minor id with merchant device and sends a request message through the Notification Engine to the merchant app.

Once the merchant app receives a notification for the initiated transaction, an message is displayed on the merchant app with Consumer's profile data and time remaining to complete the transaction.

Merchant chooses the tile image and enters the amount the consumer will confirm to pay.

On entering amount, the transaction moves to pending state and the consumer receives a notification that merchant has added an amount.

When consumer confirms the transaction, the merchant app receives notification that the transaction is complete. The transaction is then moved to transaction history.

If the consumer cancels the transaction anytime before confirming it, the merchant app receives a notification that it is cancelled and transaction is removed from the Merchant app.

This invention should not be confused with other mobile or device-based on premise payment technologies. Other mobile payments may require additional hardware components (POS terminals with readers) or leverage a proximity based protocol with limited range, requiring usage to be at an “immediate” distance such as Near Field Communications (NFC). Additionally, other mobile payment systems are also considered to be digital “wallets” acting as virtual storage for physical payment methods such as credit or debit cards. They are not new on-premise “payment methods” onto themselves.

This invention creates a new direct consumer to merchant on-premise virtual payment method powered by mobile technology. It is secure because it transmits no sensitive payment data at the point of sale, there is no need to store physical currency and does not require storage of debit, credit or bank information. The range is configurable based on distance required (unlike other forms of communication) and once connected does not require any additional location data. The direct nature of the transaction “consumer to merchant” allows for more efficient processing of funds, resulting in a safer, faster and more affordable transfer of funds.

Although the description above and accompanying drawings contains much specificity, the details provided should not be construed as limiting the scope of the embodiment, but merely as providing illustrations of some of the features of the embodiment. The drawings and the description are not to be taken as restrictive on the scope of the embodiment and are understood as broad and general teachings in accordance with the present invention. While the present embodiment has been described using specific terms, such description is for illustrative purposes only, and it is to be understood that modifications and variations to such embodiment, including, but not limited to, the substitutions of equivalent features, materials, or parts, and the reversal of various features thereof, may be practiced by those of ordinary skill in the art without departing from the spirit and scope of the invention.

1. A system for facilitating a financial transaction between a consumer and a merchant comprising:
a consumer device including a consumer transaction application;
a merchant device including a merchant transaction application; and
a core system including a notification engine and a gateway for communicating with said consumer device, said merchant device, and at least one financial institution;
wherein the consumer device and merchant device communicate to one another via Bluetooth connectivity established upon the consumer device entering the geographic proximity of the merchant device and an indication of connectivity is delivered to said core system; the core system transmits and receives messages regarding a financial transaction initiated by one of said consumer device and said merchant device; and said transaction is completed using response notifications indicating joint acceptance of said financial transaction.

2. A method for a system including a notification engine and a gateway for communicating with a plurality of applications resident in remote devices, said method for facilitating a financial transaction, comprising the steps of:
receiving a transaction request from a first device relative to a second device, at least one of said devices indicating wireless connectivity with the other of said devices;
transmitting acknowledgement to said second device via a notification engine;
receiving confirmation from said second device of receipt of said acknowledgement, said confirmation including a transaction amount;
sending a query to a financial institution associated with said first device regarding said transaction, said query directed at least to determining sufficiency of funds in an account;
receiving a response to said query; and
delivering a confirmation of said transaction to each of said first and second devices and executing said transaction.

3. The method of claim 2, wherein one of said devices is associated with a purchaser and the other of said devices is associated with a seller.

4. The method of claim 2 where said wireless connectivity is Bluetooth connectivity.

5. The method of claim 2 where said wireless connectivity to Bluetooth low energy connectivity.

6. The method of claim 2, wherein said indication of connectivity is by means of common data sent to and stored in each of said devices.

7. A multi-party transaction payment method for a consumer application on a mobile device that comprises the following steps:
opening a software application on a consumer's device at an enabled store;
initiating a link to the cloud-based system and a merchant application on a merchant's device via Bluetooth Low Energy (BLE);
initiating payment from the consumer software application to said cloud-based system indicating that a proposed transaction has been initiated within a geographic range of said merchant software application and wherein the cloud-based system receives corresponding data from the merchant software application;
receiving a payment request from the merchant software application;
accepting a request from the consumer application to make a payment and authorizing a charge for a corresponding order value by sending authorization and an order value via the merchant application to the cloud-based system and directing the cloud-based system to notify the consumer software application that the charge has been authorized;
receiving authorization and a confirmation request from the merchant application; and
confirming the transaction by sending the confirmation to the cloud-based system so that processing of the transaction can commence.

8. The system of claim 1, where said Bluetooth connectivity is Bluetooth low energy connectivity.

9. The system of claim 1, wherein said indication of connectivity is by means of common data sent to and stored in each of said devices.

10. The system of claim 1, wherein said core system further includes a database including subscriber data.

11. The method of claim 1, wherein said messages are delivered as notifications.

12. The system of claim 11, wherein said notification engine is used for sending and receiving notifications usable for determining common authorization.

13. The method of claim 2, wherein said system further includes a database including subscriber data.

14. The method of claim 2, wherein said notification engine is used for sending and receiving notifications usable for determining common authorization.

15. The method of claim 2, further including the step of receiving a response to a query to a financial institution regarding adequacy of funds.

16. The method of claim 7, wherein said indication of a link is by means of common data sent to and stored in each of said devices.

17. The method of claim 7, wherein said cloud-based system further includes a database including subscriber data.

18. The method of claim 7, wherein said cloud-based system includes a notification engine and a communication gateway.

19. The method of claim 18, wherein said notification engine is used for sending and receiving notifications usable for determining common authorization.

20. The method of claim 7, further including the step of receiving a response to a query to a financial institution regarding adequacy of funds.
